(19) United States
(12) Patent Application Publication
(10) Pub. No.: US 2026/0183975 A1
(43) Pub. Date: Jul. 2, 2026

(54) DRIVE DEVICE AND ROBOT EQUIPPED WITH DRIVE DEVICE

(71) Applicant: FANUC CORPORATION, Yamanashi (JP)

(72) Inventor: Kazutaka NAKAYAMA, Yamanashi (JP)

(21) Appl. No.: 18/868,169

(22) PCT Filed: Jun. 21, 2022
(86) PCT No.: PCT/JP2022/024742

§ 371 Date: Nov. 22, 2024

(51) Int. Cl. B25J 19/02; B25J 19/00

(52) U.S. Cl. CPC B25J 19/025; B25J 19/0029

(57) ABSTRACT

This robot comprises: a drive device which has formed therein a hollow part that extends in a direction along the axis of rotation; and an optical cable which is disposed so as to pass through the interior of the hollow part. The robot is equipped with a first supporting member and a second supporting member that support the optical cable. The first supporting member is fixed to a member that remains still during driving of the drive device. The second supporting member is fixed to a member that rotates during driving of the drive device. The first supporting member and the second supporting member are formed so as to support the optical cable on the axis of rotation.

### RELATED APPLICATIONS

The present application is a National Phase of International Application No. PCT/JP2022/024742 filed Jun. 21, 2022.

### TECHNICAL FIELD

The present invention relates to a drive device and a robot including a drive device.

### BACKGROUND ART

A robot device includes a work tool for performing a work and a robot for moving the work tool. The robot can change a position and orientation of the work tool by driving a constituent member such as an arm. The robot is provided with a drive device including an electric motor for moving the constituent member. For example, a drive device for moving each constituent member is arranged in a joint of the robot. The drive device can rotate, with respect to one constituent member, another constituent member.

It is known that a wire body such as a power cable and a signal line for driving a drive device is arranged inside a constituent member such as an arm of a robot (for example, Japanese Unexamined Patent Publication No. 2008-18475 A). In this case, a lead-through portion is formed in the drive device arranged in the joint. The wire body is inserted through the lead-through portion and arranged from an interior space of one constituent member to an interior space of another constituent member. For example, a pipe is arranged along a rotation axis, and a wire body such as a power cable is arranged inside the pipe (for example, Japanese Unexamined Patent Publication No. 2015-211999 A).

### CITATION LIST

### Patent Literature

PTL 1: Japanese Unexamined Patent Publication No. 2015-211999 A
PTL 2: Japanese Unexamined Patent Publication No. 2008-18475 A

### SUMMARY OF INVENTION

### Technical Problem

In the joint of the robot, a relative angle between constituent members changes so that one constituent member rotates relative with respect to another constituent member. When the wire body is arranged inside the constituent member of the robot, a direction in which the wire body extends changes together with the rotation of the constituent member. For this reason, a force in a predetermined direction is applied to the wire body arranged in the joint. For example, a bending force or twisting force acts on the wire body.

In the prior art, electric wires have been used as communication lines for transmitting control signals. However, when an electric wire is used as a communication line, there is a problem in that an electric signal is likely to be affected by noise. Alternatively, electromagnetic noise may be generated from the electric wire. Therefore, an optical cable can be used as the communication line instead of the electric wire. When the optical cable is used as the communication line, the optical cable does not serve to be a source of electromagnetic noise and is hardly affected by noise from the surroundings. However, the optical cable may be damaged by the force applied, depending on movement of the constituent member of the robot.

### Solution to Problem

A robot according to an aspect of the present disclosure includes a drive device configured to rotate a second constituent member of the robot around a rotation axis with respect to a first constituent member of the robot. The robot includes a member including a hollow portion extending in a direction along the rotation axis. The robot includes an optical cable arranged so as to pass through an inside of the hollow portion. The robot includes a first support member arranged on one side in an axial direction of the hollow portion and configured to support the optical cable, and a second support member arranged on a side opposite to the one side in the axial direction of the hollow portion and configured to support the optical cable. The first support member is fixed to a member that is stationary when the drive device is driven. The second support member is fixed to a member that rotates when the drive device is driven. The first support member and the second support member are configured to support the optical cable substantially on the rotation axis. The first support member and the second support member are configured such that when the drive device is driven, the second support member rotates with respect to the first support member so that the optical cable is twisted between the first support member and the second support member.

A drive device according to an aspect of the present disclosure is configured to relatively rotate two members different from each other around a rotation axis, and includes a hollow portion extending in a direction along the rotation axis. The drive device includes an electric motor configured to generate a rotational force. The drive device includes a first support member arranged on one side in an axial direction of the hollow portion and configured to support an optical cable so as to pass through an inside of the hollow portion, and a second support member arranged on a side opposite to the one side in the axial direction of the hollow portion and configured to support the optical cable. The first support member is fixed to a constituent member of the drive device that is stationary when the electric motor is driven. The second support member is fixed to a constituent member of the drive device that rotates when the electric motor is driven. The first support member and the second support member are configured to support the optical cable substantially on the rotation axis. The first support member and the second support member are configured such that when the electric motor is driven, the second support member rotates with respect to the first support member so that the optical cable is twisted between the first support member and the second support member.

### Advantageous Effects of Invention

According to an aspect of the present disclosure, it is possible to provide a drive device that reduces the possibility of damage to an optical cable serving as a communication line and a robot including the drive device.

### BRIEF DESCRIPTION OF DRAWINGS

FIG. 1 is a perspective view of a robot according to an embodiment.

FIG. 2 is a schematic cross-sectional view of a joint where a first drive device according to the embodiment is arranged.

FIG. 3 is a schematic partial cross-sectional view when the first drive device is viewed from a second support member side.

FIG. 4 is a perspective view of an optical cable according to the embodiment.

FIG. 5 is a schematic cross-sectional view of the optical cable.

FIG. 6 is a schematic cross-sectional view of a joint where a second drive device according to the embodiment is arranged.

FIG. 7 is a schematic cross-sectional view of a joint where a third drive device according to the embodiment is arranged.

FIG. 8 is a schematic cross-sectional view of a joint where a fourth drive device according to the embodiment is arranged.

FIG. 9 is a schematic partial cross-sectional view of the fourth drive device when viewed from a second support member side.

FIG. 10 is a schematic partial cross-sectional view of a fifth drive device according to the embodiment when viewed from a second support member side.

FIG. 11 is a schematic partial cross-sectional view of a sixth drive device according to the embodiment when viewed from a second support member side.

### DESCRIPTION OF EMBODIMENTS

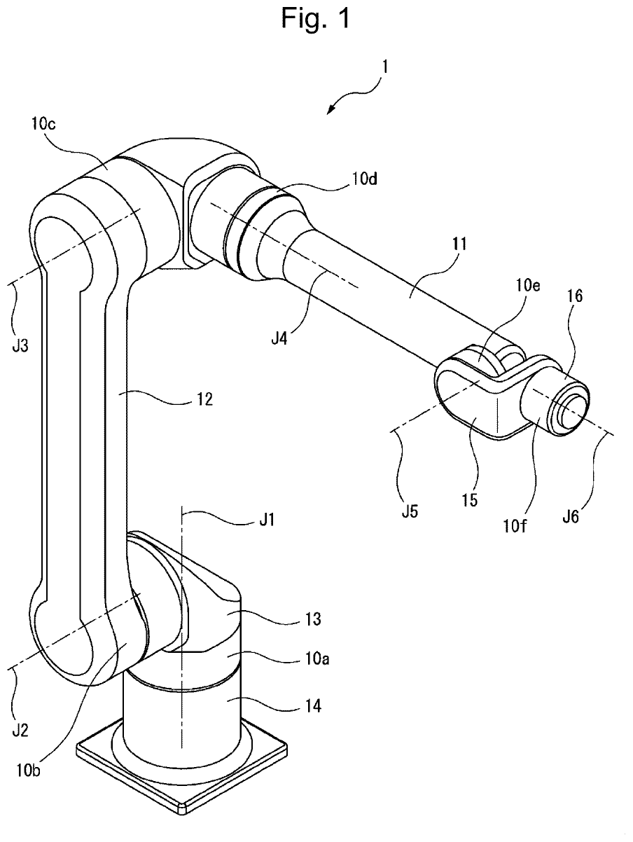

Referring to FIGS. 1 to 11, a drive device and a robot including the drive device according to an embodiment will be described. The drive device according to the present embodiment rotates, with respect to one constituent member of the robot, another constituent member around a predetermined rotation axis. An optical cable is arranged as a communication line for transmitting information to the drive device or for receiving information from the drive device.

FIG. 1 is a perspective view of a robot according to the present embodiment. The robot 1 according to the present embodiment is an articulated robot including a plurality of joints 10a to 10f. The robot 1 according to the present embodiment is a cooperative robot that can perform a work in cooperation with an operator. The cooperative robot is configured such that an operation of the robot 1 is limited when a predetermined external force acts on the robot 1. For example, the cooperative robot is configured to detect that the operator has come into contact with the robot and stop the robot 1.

The robot 1 includes a plurality of rotatable constituent members in the joints 10a to 10f. The constituent members are configured so as to rotate around drive axes J1 to J6 as rotation axes, respectively. The drive device according to the present embodiment is arranged inside the joints 10a to 10f so as to drive the constituent members of the robot 1.

The robot 1 includes a base part 14 fixed to an installation surface and a swivel base 13 supported by the base part 14. The swivel base 13 rotates around the drive axis J1 with respect to the base part 14. An upper arm 12 of the robot 1 rotates around the drive axis J2 with respect to the swivel base 13. A front arm 11 of the robot 1 rotates about the drive axis J3 with respect to the upper arm 12. Further, the front arm 11 rotates around the drive axis J4 parallel to a direction in which the front arm 11 extends. The robot 1 includes a wrist 15 supported by the front arm 11. The wrist 15 rotates around the drive axis J5. Further, the wrist 15 includes a flange 16 that rotates around the drive axis J6. A work tool corresponding to a work that is performed by a robot device is fixed to the flange 16.

The robot 1 according to the present embodiment includes, as constituent members thereof, the base part 14, the swivel base 13, the upper arm 12, the front arm 11, and the wrist 15. The robot according to the present embodiment includes six drive axes, but the embodiment is not limited thereto. A robot that changes the position and orientation by any mechanism can be employed.

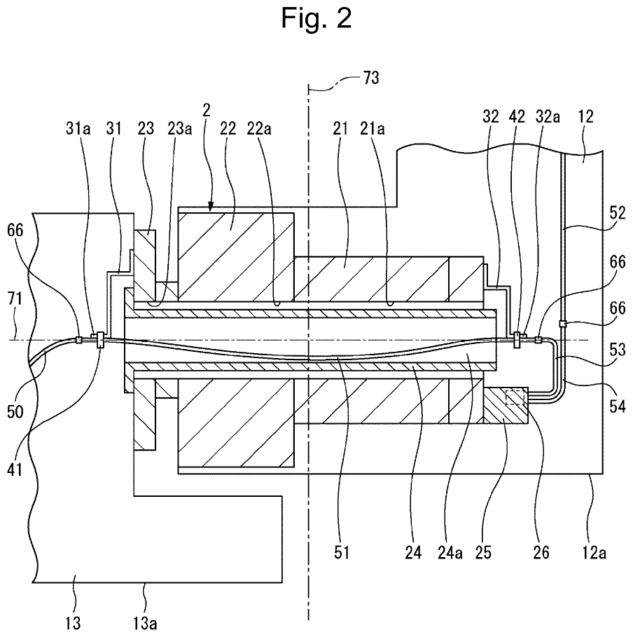

FIG. 2 illustrates a schematic cross-sectional view of a joint including a first drive device according to the present embodiment. Referring to FIGS. 1 and 2, a first drive device 2 is arranged in the joint 10b. The first drive device 2 rotates, with respect to the swivel base 13 as a first constituent member, the upper arm 12 as a second constituent member around the drive axis J2 as a rotation axis 71.

In the present embodiment, a drive device that drives the upper arm 12 arranged in the joint 10b is described as an example, but embodiment is not limited thereto. The drive device according to the present embodiment can be arranged in a joint that rotates, with respect to the first constituent member of the robot, the second constituent member of the robot around the rotation axis. In other words, the drive device according to the present embodiment can be arranged in any joint and rotate any constituent member.

The drive device 2 includes an electric motor 21 that generates a rotational force, and a reduction gear 22 that amplifies torque output by the electric motor 21. When the electric motor 21 is driven, the drive device 2 is driven. A housing of the reduction gear 22 is fixed to a housing 12a of the upper arm 12. The electric motor 21 is fixed to the reduction gear 22. When the electric motor 21 is driven, the reduction gear 22 and the electric motor 21 rotate around the rotation axis 71 together with the housing 12a of the upper arm 12.

The drive device 2 includes a torque sensor 23 that detects torque output from the drive device 2. The torque sensor 23 according to the present embodiment includes an inner race part, an outer race part, and a plurality of spoke-shaped detection parts connecting the inner race part and the outer race part. The outer race part of the torque sensor 23 is fixed to a housing 13a of the swivel base 13, and the inner race part is fixed to an output part of the reduction gear 22. The housing 13a of the swivel base 13 and the torque sensor 23 remain stationary without rotating when the electric motor 21 is driven. The torque sensor 23 detects torque around the rotation axis 71 when the drive device 2 is driven. A controller of the robot receives a signal related to the torque via the communication line. The controller of the robot subtracts the moment related to a self-weight of the robot and the moment related to an operation of the robot from the torque detected by the torque sensor. The calculated moment corresponds to an external force applied to the robot.

When the external force is greater than a predetermined determination value, the controller of the robot can restrict an operation of the robot. The drive device according to the present embodiment includes the torque sensor, but the embodiment is not limited thereto. The torque sensor may not be arranged in the drive device. In this case, an output shaft of the reduction gear can be fixed to the housing 13a of the swivel base 13.

The drive device 2 according to the present embodiment includes a protective tube 24 as a member including a hollow portion 24a extending in a direction along the rotation axis 71. A space inside the protective tube 24 corresponds to the hollow portion 24a penetrating from one end face to the other end face of the drive device 2. The member including the hollow portion 24a according to the present embodiment is arranged in the drive device 2. The electric motor 21 has a hollow portion 21a extending in a direction along the rotation axis 71. The reduction gear 22 has a hollow portion 22a extending in the direction along the rotation axis 71. The torque sensor 23 has a hollow portion 23a extending in the direction along the rotation axis 71. In the present embodiment, these hollow portions 21a, 22a, and 23a have substantially the same inner diameters and are arranged coaxially. The protective tube 24 is arranged inside the hollow portions 21a, 22a, and 23a so as to pass through the hollow portions 21a, 22a, and 23a. In the present embodiment, the protective tube 24 is arranged in the joint 10b of the robot 1. The hollow portion 24a is formed coaxially with the rotation axis 71, but the embodiment is not limited thereto. An axis line of the hollow portion 24a may be separate from the rotation axis 71. Further, the member including the hollow portion may be a member arranged outside the drive device. In other words, the hollow portion through which the optical cable is inserted may not be formed inside the drive device. For example, a hollow portion may be formed in a housing of a constituent member of the robot.

The protective tube 24 according to the present embodiment is formed of resin. A wire body can be inserted into the protective tube 24. In the present embodiment, a linearly extending member is referred to as a wire body. At least a part of the wire body according to the present embodiment is laid inside a housing of a constituent member of the robot 1 such as an arm. The protective tube 24 is arranged so as to protect the wire body arranged therein. A flange portion at a distal end of the protective tube 24 is fixed to the inner race part of the torque sensor 23. The protective tube 24 remains stationary when the electric motor 21 is driven. It should be noted that the protective tube 24 may not be arranged. For example, the hollow portions 21a, 22a, and 23a may constitute a hollow portion penetrating the drive device. In this case, the electric motor 21, the reduction gear 22, and the torque sensor 23 correspond to members forming the hollow portion.

In the robot 1 according to the present embodiment, the drive device is arranged for each of the joints 10a to 10f. In other words, one drive device is arranged in one joint. The plurality of drive devices of the robot 1 according to the present embodiment are configured to perform serial communication with each other. The drive device 2 includes a driver 25 that controls electricity supplied to the electric motor 21. The driver 25 includes, for example, an inverter, converts DC electricity into AC electricity, and supplies the AC electricity to the electric motor 21. A signal for controlling the electric motor 21 is transmitted from the controller of the robot to the driver 25.

In the present embodiment, as a communication line connected to the driver 25, an electric wire is not used, and instead an optical cable 51 is employed. In other words, the optical cable 51 is employed as a signal line of the drive device 2. The optical cable 51 connects the drive devices arranged in the respective joints. Alternatively, the optical cable 51 connects the drive device arranged in the joint and the controller of the robot. For example, an electric signal can be converted into an optical signal, and the signal can be transmitted or received by an optical cable.

In the present embodiment, any communication protocol capable of serial communication through an optical cable can be employed. For example, communication protocols for optical communication that is similar to industrial Ethernet (registered trademark) such as EtherCAT (registered trademark) or fieldbus-like methods such as RS-485 can be adopted. It should be noted that the communication method of the drive device of the robot is not limited to serial communication, and any method can be employed. For example, parallel communication may be performed by an optical cable.

In the present embodiment, the controller of the robot is connected to the driver of the drive device arranged on the drive axis J1 by the optical cable. The driver of the drive device arranged on the drive axis J1 is connected to the driver 25 of the drive device 2 arranged on the drive axis J2 shown in FIG. 2 by the optical cable. In addition, the driver 25 of the drive device 2 arranged on the drive axis J2 is connected to the driver of the drive device arranged on the drive axis J3 by the optical cable. In this way, the drive devices adjacent to each other are connected to each other by the optical cable up to the drive device arranged on the drive axis J6.

The information communicated through the optical cable includes a position command of the electric motor of each drive device, a rotational speed command of the electric motor, a current command of the electric motor, a voltage command of the electric motor, and the like. In other words, information about the electricity supplied to the electric motor is included. The information about the electricity of each driver is generated by the controller of the robot and received by each drive device via the communication line.

In addition, the information communicated through the optical cable may include information detected by a sensor arranged in the robot. For example, information about a position or speed detected by a rotational position detector (encoder) attached to the electric motor and information about a current detected by a current detector arranged in the driver are included. In this regard, information about the torque output from the torque sensor may be included. The information about the outputs of these sensors is included in the signals output from the driver. The information communicated through the optical cable includes at least one of the plurality of pieces of information described above.

The driver 25 of the drive device 2 includes a communication device 26 that transmits and receives information communicated through the optical cable. The communication device 26 according to the present embodiment is arranged in the drive device 2. Referring to FIG. 2, the driver of the drive device arranged on the drive axis J1 is connected to an optical cable 50. The optical cable 50 is connected to the optical cable 51 via a connector 66. The optical cable 51 is inserted through the hollow portion 24a inside the protective tube 24. The optical cable 51 is connected to an optical cable 53 extending from the communication device 26 of the driver 25 via the connector 66.

In addition, another optical cable 54 extending from the communication device 26 of the driver 25 is connected to an optical cable 52 via the connector 66. The optical cable 52 is connected to the driver of the drive device arranged on the drive axis J3. As such, optical communication can be performed by adopting the optical cable as the communication line and arranging the communication device for optical communication in the robot 1.

The optical cable according to the present embodiment includes two optical fibers as at least two signal lines. One signal line transmits a signal from the drive device arranged on the drive axis J1 toward the drive device arranged on the drive axis J6. The other signal line transmits a signal from the drive device arranged on the drive axis J6 toward the drive device arranged on the drive axis J1.

A power cable for supplying power for driving the electric motor 21 is connected to the driver 25 of the drive device 2. In the first drive device 2, the power cable for supplying electricity to the electric motor 21 can be laid, for example, outside the housing of the robot. As such, the power cable may not be arranged inside the constituent member of the robot.

The signal from the driver of the drive device arranged on the drive axis J1 includes a signal for driving the electric motor 21 on the drive axis J2. For example, a signal for controlling an inverter that generates current to be supplied to the electric motor 21 is included. The driver 25 of the drive device 2 supplies electricity to the electric motor 21 based on the signal for driving the electric motor 21.

In addition, the driver 25 of the drive device 2 includes information about the output of the sensor arranged in the drive device 2 in the output signal. For example, the driver 25 includes at least one piece of information selected from a group of the output of the torque sensor 23, the output of the rotational position detector, or the output of the current detector in the signal output from the driver 25.

The communication device 26 according to the present embodiment is arranged inside the housing 12a of the upper arm 12 as a second constituent member of the robot 1. By arranging the communication device 26 inside the housing of the constituent member of the robot, it is possible to suppress an increase in the size of the robot.

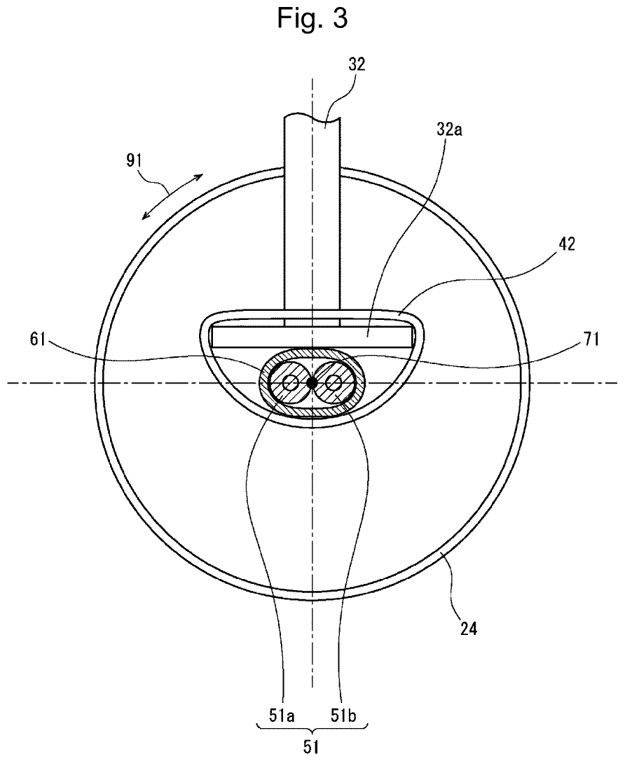

FIG. 3 illustrates a partial cross-sectional view of a portion of a second support member in the first drive device. Referring to FIGS. 2 and 3, the drive device 2 according to the present embodiment includes a first support member 31 and a second support member 32 supporting the optical cable 51. The first support member 31 and the second support member 32 are each formed so as to support one point of the optical cable 51. The first support member 31 is fixed to a member that is stationary when the drive device 2 is driven. In this example, the first support member 31 is fixed to the housing 13a of the swivel base 13. Alternatively, the first support member 31 may be fixed to the inner race part of the torque sensor 23.

The second support member 32 is fixed to a member that rotates when the drive device 2 is driven. In this example, the second support member 32 is fixed to the housing of the electric motor 21. When the electric motor 21 is driven, the second support member 32 rotates around the rotation axis 71 together with the housing of the electric motor 21, as indicated by an arrow 91. It should be noted that the second support member 32 may be fixed to the housing 12a.

FIGS. 2 and 3 illustrate a state in which the robot is stopped at a reference position. The second support member 32 is arranged in the same phase as the phase of the first support member 31. The first support member 31 and the second support member 32 support the wire body such as the optical cable 51 so that the wire body is bent in a section between the first support member 31 and the second support member 32.

In the present embodiment, the wire body is fixed to the first support member 31 and the second support member 32 by the same method. The first support member 31 has a fixing portion 31a at a distal end. The fixing portion 31a has a plate shape. The optical cable 51 is fixed to the fixing portion 31a by a binding band 41. Similarly, the second support member 32 has a fixing portion 32a at a distal end. The fixing portion 32a has a plate shape. The optical cable 51 is fixed to the fixing portion 32a by a binding band 42. The binding bands 41 and 42 can be configured by an elastic member such as nylon. It should be noted that although the fixing portions 31a and 32a according to the present embodiment are formed so as to face an outer side of the protective tube 24 in the direction of the rotation axis 71, the embodiment is not limited thereto, and the fixing portions may be formed so as to face an inner side of the protective tube 24 in the direction of the rotation axis 71. Furthermore, each support member may be bent toward the inside of the protective tube so that the fixing portion is arranged inside the protective tube.

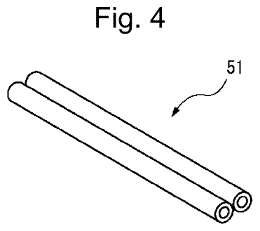

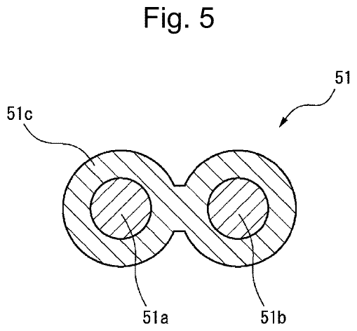

FIG. 4 illustrates a perspective view of the optical cable according to the present embodiment. FIG. 5 illustrates a cross-sectional view of the optical cable of the present embodiment. FIG. 5 is a cross-sectional view when cut along a plane perpendicular to the direction in which the optical cable 51 extends. In the present embodiment, one linear member including one core wire is referred to as an optical fiber. For example, the core wire includes a core as a linear light propagation part and has a structure in which the periphery of the core is covered with a resin. The core may be formed of, for example, quartz glass or plastic such as acrylic resin. In addition, the optical fiber may have a structure in which the periphery of the core wire is further covered with a sheath of resin or the like. In the present embodiment, a communication line including at least one optical fiber is referred to as an optical cable. For example, the optical cable may have a structure in which a plurality of optical fibers are integrated with a resin.

Referring to FIGS. 4 and 5, the optical cable 51 according to the present embodiment has a structure in which two optical fibers 51a and 51b are fixed to each other and integrated. The two optical fibers 51a and 51b are fixed to each other by a sheath 51c of resin. The optical fibers 51a and 51b are fixed so as to extend parallel to each other, respectively.

As such, the optical cable 51 according to the present embodiment has a structure in which the pair of optical fibers 51a and 51b are fixed to each other. In the present embodiment, in order to perform serial communication, a communication line for transmitting information toward the drive device on the drive axis J6 at the distal end of the robot 1 and a communication line for transmitting information from the drive axis J6 at the distal end toward the drive axis J1 and the controller of the robot are required.

The optical cable 51 according to the present embodiment includes two optical fibers 51a and 51b, which are the minimum number required for serial communication. Since the two optical fibers 51a and 51b are fixed to each other and integrated, a diameter of the optical cable 51 can be reduced. This makes it possible to reduce the size of the drive device 2. Alternatively, a ratio of the optical cable 51 accounting for the hollow portion 24a is reduced, and another wire body can be arranged in the hollow portion 24a. In addition, according to this configuration, workability when the optical cable is laid inside a constituent component such as an arm of a robot is improved. It should be noted that the optical cable according to the present embodiment is configured by the two optical fibers; however, the embodiment is not limited thereto. The optical cable may include any number of optical fibers.

In the present embodiment, in order to protect the optical cable 51, a buffer material 61 is wound around the optical cable 51. The buffer material 61 may be configured by an elastic material such as sponge or rubber. The buffer material 61 can be arranged in a region fixed to the fixing portions 31a and 32a by the binding bands 41 and 42, for example. Alternatively, referring to FIG. 2, the buffer material 61 may be arranged around the optical cable 51 in a section from the connector 66 arranged on one side in the axial direction of the protective tube 24 to the connector 66 arranged on the other side in the axial direction of the protective tube 24. Alternatively, the buffer material is not necessarily arranged around the optical cable.

As a result of studies and experiments on damage to the optical cable caused by various movements of the optical cable, the inventor has found that the optical cable is relatively weak against bending movement but relatively strong against twisting movement. In other words, it has been found that the optical cable is more resistant to twisting movement around the axis line of the optical cable than movement changing the extension direction. Based on the feature, the inventor has conceived a structure in which the bending movement of the optical cable is suppressed and the twisting movement preferentially occurs as in the present embodiment.

In the state illustrated in FIG. 2, the first support member 31 and the second support member 32 are arranged in the same phase. In the state illustrated in FIG. 2, the second support member 32 is arranged at a predetermined reference position. A cross-sectional shape of the wire body in the first support member 31 and a cross-sectional shape of the wire body in the second support member 32 are plane-symmetrical to each other with respect to a central plane 73 of the hollow portion 24a in the direction of the axis line (rotation axis 71). Referring to FIGS. 2 and 3, the optical cable 51 is fixed to the fixing portions 31a and 32a such that the optical fibers 51a and 51b are aligned horizontally. The optical cable 51 is arranged on the rotation axis 71.

In the present embodiment, the first support member 31 is arranged on one side in the axial direction of the hollow portion 24a. In particular, the first support member 31 is arranged on one side with respect to the central plane 73 in the axial direction of the hollow portion 24a of the protective tube 24. The second support member 32 is arranged on a side opposite to the one side in the axial direction of the hollow portion 24a. In particular, the second support member 32 is arranged opposite to the first support member 31 with respect to the central plane 73 in the axial direction of the hollow portion 24a. The first support member 31 and the second support member 32 are arranged opposite each other with respect to the central plane 73 of the hollow portion 24a. The first support member 31 and the second support member 32 are preferably arranged in the vicinity of outlets on both sides of the hollow portion 24a.

The first support member 31 and the second support member 32 are formed so as to support the optical cable 51 substantially on the rotation axis 71. In this regard, “supported substantially on the rotation axis” means supported on the rotation axis or in the vicinity of the rotation axis. In other words, the first support member 31 and the second support member 32 are formed so as to support the optical cable 51 on the rotation axis 71 or in the vicinity of the rotation axis 71. For example, referring to FIG. 3, in the fixing portions 31a and 32a, it is preferable that the rotation axis 71 is arranged inside the region of the optical cable 51 when the fixing portions 31a and 32a are cut. Alternatively, for example, the position of the center of gravity of the cross-sectional shape of the optical cable 51 is preferably arranged in a region that is half the inner diameter of the protective tube 24.

When the electric motor 21 is driven, the second support member 32 rotates with respect to the first support member 31. The second support member 32 rotates around the rotation axis 71 in a direction indicated by the arrow 91 together with the electric motor 21 and the upper arm 12. Even when the upper arm 12 rotates, the fixing portion 32a is maintained on the rotation axis 71 or in the vicinity of the rotation axis 71.

When the fixing portion 32a rotates around the rotation axis 71, a movable portion of the optical cable 51 is twisted between the first support member 31 and the second support member 32. Since the first support member 31 and the second support member 32 support the optical cable 51 on the rotation axis 71 or in the vicinity of the rotation axis 71, it is possible to suppress occurrence of bending movement of the optical cable 51. Since the optical cable 51 is resistant to damage due to twisting movement, damage to the optical cable 51 can be suppressed.

Further, in the present embodiment, when the phase of the first support member 31 and the phase of the second support member 32 are the same, the optical cable 51 is supported so as to be bent between the first support member 31 and the second support member 32. For this reason, when the electric motor 21 is driven and the optical cable 51 is twisted, it is possible to suppress application of a strong tension in the direction in which the optical cable 51 extends.

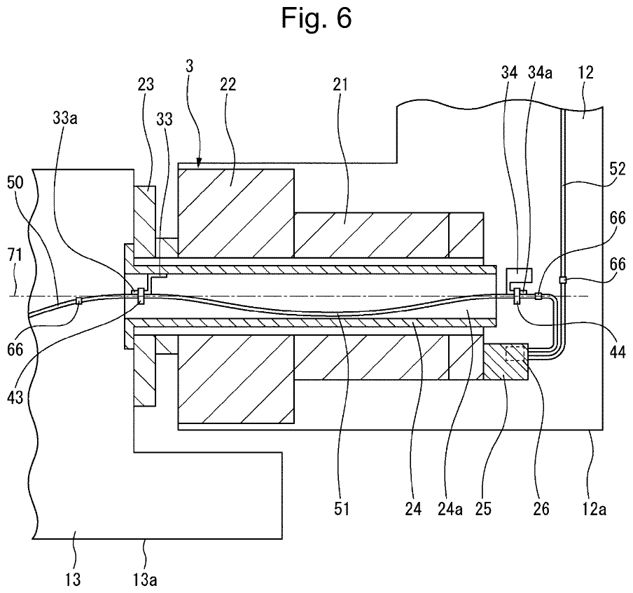

FIG. 6 illustrates an enlarged schematic cross-sectional view of a joint including a second drive device according to the embodiment. A second drive device 3 is different from the first drive device 2 in the position of the support member. In the second drive device 3, a first support member 33 is fixed to an inner peripheral surface of the protective tube 24. The optical cable 51 is fixed to the first support member 33 by a binding band 43 at a fixing portion 33a. The first support member 33 is fixed to a member that is stationary when the electric motor 21 is driven. The first support member 33 supports the optical cable 51 on the rotation axis 71 or in the vicinity of the rotation axis 71.

A second support member 34 is fixed to an arm that rotates when the electric motor 21 is driven. The second support member 34 is fixed to an inner surface of the housing 12a of the upper arm 12. The optical cable 51 is fixed to the second support member 34 by a binding band 44 at a fixing portion 34a. The second support member 34 is formed so as to support the optical cable 51 on the rotation axis 71 or in the vicinity of the rotation axis 71 even when the electric motor 21 is driven. Also in the second drive device 3, it is possible to suppress the bending movement of the optical cable 51 when the electric motor 21 is driven, thereby suppressing damage to the optical cable 51.

It should be noted that since the first support member can be fixed to a member that is stationary even when the electric motor 21 is driven, the first support member may be fixed to, for example, the inner surface of the housing 13a of the swivel base 13. On the other hand, the second support member can be fixed to a member that rotates when the electric motor 21 is driven. For this reason, for example, when the electric motor includes an encoder, the second support member may be fixed to a housing of the encoder.

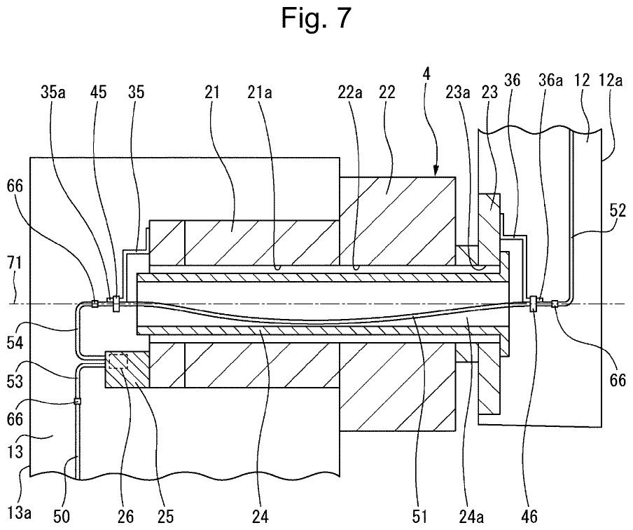

FIG. 7 illustrates an enlarged schematic cross-sectional view of a joint including a third drive device according to the embodiment. A third drive device 4 is different from the first drive device 2 and the second drive device 3 in the orientation with respect to the constituent members of the robot 1. In the third drive device 4, the electric motor 21 and the reduction gear 22 are fixed to the housing 13a of the swivel base 13. On the other hand, the torque sensor 23 is fixed to the housing 12a of the upper arm 12.

In the third drive device 4, the torque sensor 23 coupled to the output shaft of the reduction gear 22 rotates together with the upper arm 12 when the electric motor 21 is driven. On the other hand, the electric motor 21 and the reduction gear 22 remain stationary when the electric motor 21 is driven. In the third drive device 4, a first support member 35 is fixed to the housing of the electric motor 21. The optical cable 51 is fixed to a fixing portion 35a of the first support member 35 by a binding band 45. A second support member 36 is fixed to the inner race part of the torque sensor 23. The optical cable 51 is fixed to a fixing portion 36a of the second support member 36 by a binding band 46. The fixing portions 35a and 36a are each formed so as to support the optical cable 51 on the rotation axis 71 or in the vicinity of the rotation axis 71.

The driver 25 including the communication device 26 is arranged inside the housing 13a of the swivel base 13 as the first constituent member. The driver 25 is connected to the driver of the drive device arranged on the drive axis J1 via the optical cables 50 and 53. The driver 25 is connected to the driver of the drive device arranged on the drive axis J3 via the optical cables 54, 51, and 52. The optical cable 51 is inserted through the hollow portion 24a inside the protective tube 24.

In the third drive device 4, when the electric motor 21 is driven, the fixing portion 36a of the second support member 36 rotates around the rotation axis 71. The fixing portion 35a of the first support member 35 is stationary. As a result, the optical cable 51 undergoes twisting movement. The bending movement of the optical cable 51 can be suppressed, and damage to the optical cable 51 can be suppressed. It should be noted that, in the third drive device 4, the first support member may be fixed to the housing 13a of the swivel base 13. In addition, the second support member may be fixed to the housing 12a of the upper arm 12.

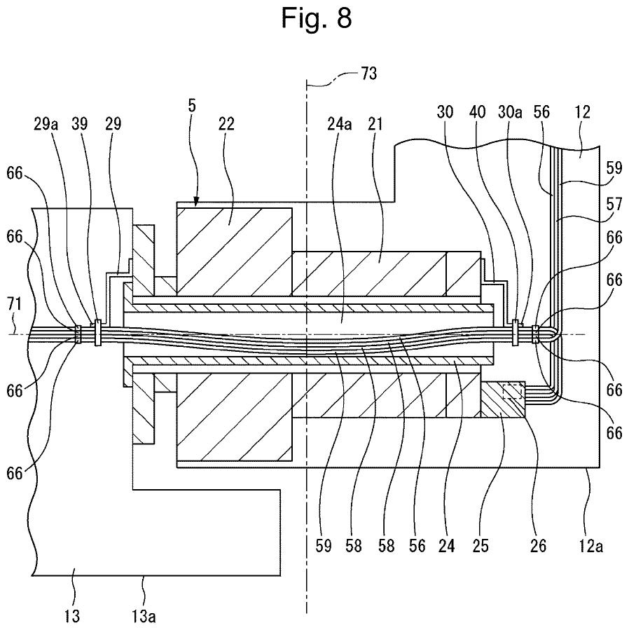

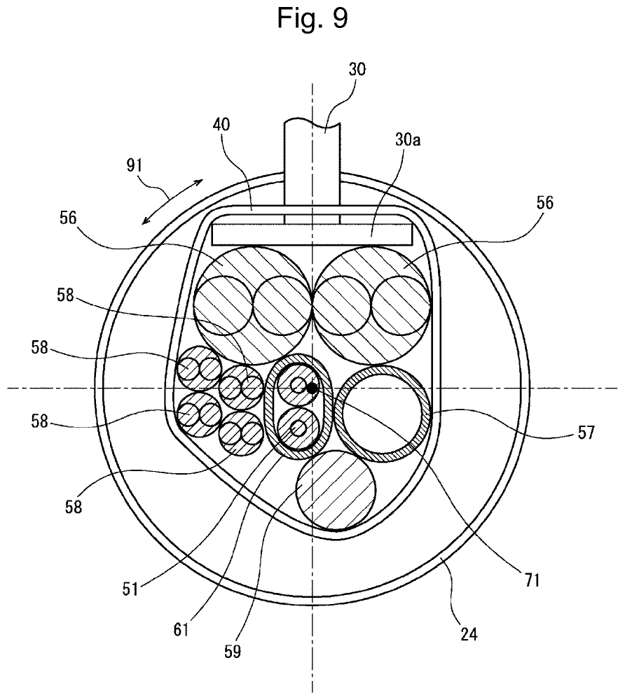

FIG. 8 illustrates an enlarged schematic cross-sectional view of a joint including a fourth drive device according to the embodiment. FIG. 9 illustrates a schematic partial cross-sectional view of a portion of a second support member of the fourth drive device according to the embodiment. In the drive devices 2, 3, and 4 described above, one optical cable 51 is arranged in the hollow portion 24a inside the protective tube 24, but the embodiment is not limited thereto. A plurality of wire bodies can be arranged inside a constituent member of the robot. A plurality of wire bodies other than the optical cable 51 can be inserted into the hollow portion of the drive device so as to pass through the joint.

Referring to FIGS. 8 and 9, a fourth drive device 5 is different from the first drive device 2 in that a first support member 29 and a second support member 30 support a plurality of wire bodies. A plurality of wire bodies are fixed to each of the support members 29 and 30 by binding bands 39 and 40. The wire body according to the present embodiment includes a power cable 56 as an electric wire for supplying electricity for driving the electric motor 21 to the driver 25, an air supply tube 57 for supplying pressurized air for driving a work tool, an electric wire 58 for supplying backup electricity to a rotational position detector (encoder), and a communication cable 59 for transmitting a signal for driving the work tool. Since the communication cable 59 is constituted by an electric cable, it is included in the electric wire. The wire body is not limited to this embodiment. It is possible to adopt any wire body that is resistant to twisting or bending.

The binding band 40 is arranged so as to surround the plurality of wire bodies. The binding band 40 integrally fixes the plurality of wire bodies to the fixing portion 30a so as to be bundled. Each of the wire bodies is arranged so as to pass through the hollow portion 24a inside the protective tube 24. In the first support member 29, when the second support member 30 is arranged in the same phase as that of the first support member 29, the plurality of wire bodies are arranged so as to be plane-symmetrical with respect to the central plane 73 with respect to the arrangement of the wire bodies of the second support member 30. In a section between the fixing portion 29a and the fixing portion 30a, the plurality of wire bodies are supported so as to be bent. In addition, in the section between the fixing portion 29a and the fixing portion 30a, the plurality of wire bodies are not fixed and are arranged so as to be freely deformable. In the section between the fixing portion 29a and the fixing portion 30a, the wire bodies are separated from each other when the drive device is driven, so that damage to the wire body can be suppressed.

The first support member 29 and the second support member 30 support the optical cable 51 in the vicinity of the rotation axis 71. The first support member 29 and the second support member 30 support the power cable 56, the backup electric wire 58, and the communication cable 59 as electric wires at positions farther from the rotation axis 71 than the optical cable 51.

As a result of studies and experiments on damage to electric wires, the inventor has found that when a bundle of electric wires is subjected to reciprocating twisting movement, the closer the bundle of electric wires is arranged to the rotation axis, the shorter the life until a conductor portion of the electric wire is broken due to metal fatigue. In the fourth drive device 5, by arranging the electric wires at positions away from the rotation axis 71, it is possible to extend the lives of the electric wires. In addition, in the fourth drive device 5, the optical cable 51 is arranged in the vicinity of the rotation axis 71. For this reason, in the fourth drive device 5, the lives of the optical cable 51, the power cable 56, the electric wire 58, and the communication cable 59 can be extended.

As described above, in the fixing portions 29a and 30a, it is preferable that the optical cable 51 is arranged on the rotation axis 71 or in the vicinity of the rotation axis 71, and the wire bodies other than the optical cable 51, such as electric wires, are arranged around the optical cable 51. Alternatively, in the cross section of the bundle of the plurality of wire bodies, the optical cable 51 can be arranged at the central portion, and the electric wires can be arranged at the outer peripheral portion outside the central portion. With this configuration, it is possible to extend the lives of the wire bodies of both the optical cable and the electric wire.

It should be noted that the air supply tube 57 for supplying compressed air is made of a flexible material. The air supply tube 57 is made of, for example, polyurethane. The air supply tube 57 has a feature that it is less likely to be damaged due to both bending and twisting movements. For this reason, the air supply tube 57 can be arranged at an arbitrary position in the cross section of the bundle of wire bodies.

As a member for fixing the wire body to the fixing portion, a metal binding band may be employed in addition to the above-described nylon band. When the metal band is employed, it is preferable to arrange a buffer material on an inner peripheral surface of the metal band so that the wire body is not damaged due to contact with the metal band.

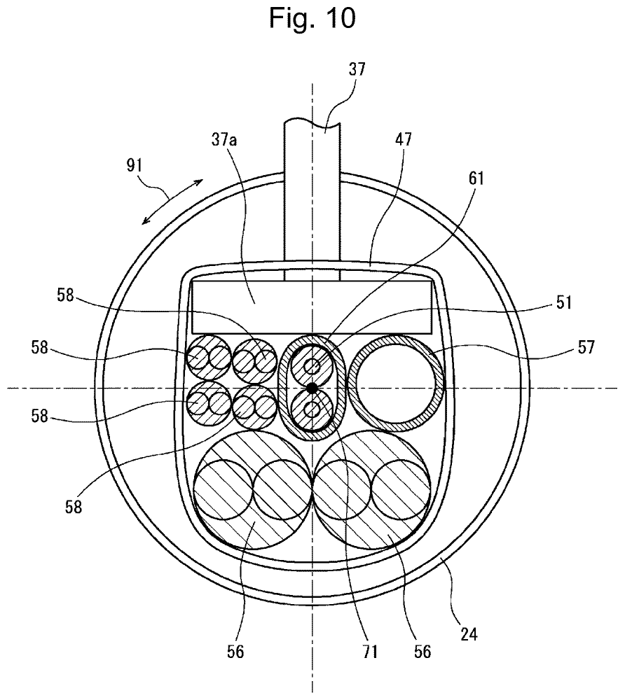

FIG. 10 illustrates an enlarged schematic cross-sectional view of a portion of a second support member of a fifth drive device according to the embodiment. In the fifth drive device, the arrangement of the plurality of wire bodies in the cross section of the support member is different from that in the fourth drive device 5. The fifth drive device includes a second support member 37 having a fixing portion 37a. A plurality of wire bodies are fixed to the fixing portion 37a by a binding band 47. The first support member supports the plurality of wire bodies with a structure similar to that of the second support member 37.

In the fifth drive device, the optical cable 51 is in contact with the fixing portion 37a via a buffer material 61. The optical cable 51 is in contact with substantially the widthwise center of the fixing portion 37a. In this state, the position of the fixing portion 37a is adjusted so that the optical cable 51 is arranged on the rotation axis 71. The power cable 56 and the electric wire 58 are arranged around the optical cable 51. In addition, the air supply tube 57 is arranged around the optical cable 51. In the fifth drive device, the plurality of wire bodies can be bound in a state in which the optical cable 51 is in contact with the widthwise center of the fixing portion 37a. For this reason, the optical cable 51 can be easily arranged on the rotation axis 71 to fix the wire bodies.

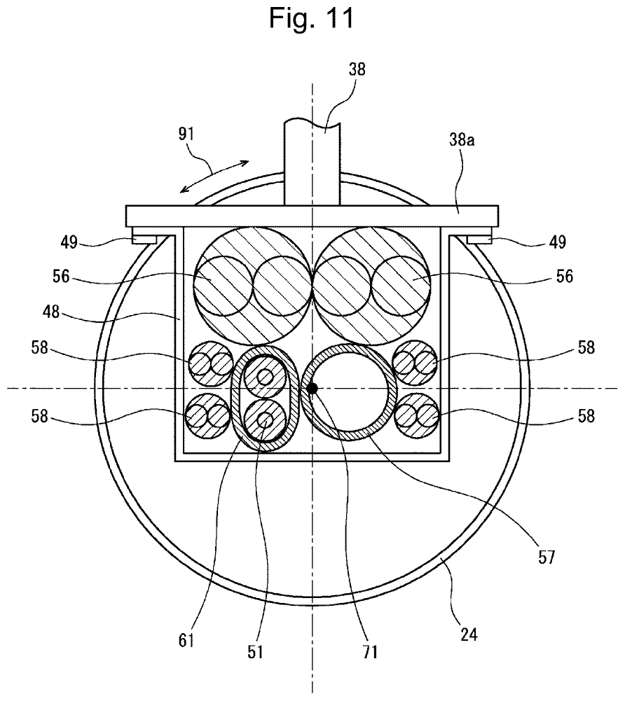

FIG. 11 illustrates an enlarged schematic cross-sectional view of a portion of a second support member of a sixth drive device according to the embodiment. The sixth drive device includes a second support member 38 having a fixing portion 38a. The first support member supports the wire body with a configuration similar to that of the second support member 38.

In the sixth drive device, the optical cable 51 and the air supply tube 57 are arranged in the vicinity of the rotation axis 71. The power cable 56 and the electric wire 58 are arranged around the optical cable 51 and the air supply tube 57. The optical cable 51 and the air supply tube 57 are arranged at a central portion of the hollow portion 24a. The power cable 56 and the electric wire 58 are arranged at an outer peripheral portion around the central portion. The first support member and the second support member 38 support the electric wire at positions farther from the rotation axis 71 than the optical cable 51 and the air supply tube 57.

As described above, the electric wire is preferably arranged at a position away from the rotation axis 71. The air supply tube 57 can be used as a spacer because of its large diameter. By arranging the optical cable 51 and the air supply tube 57 in the vicinity of the rotation axis 71 and arranging the electric wire around the optical cable 51 and the air supply tube 57, it is possible to arrange the electric wire at a position away from the rotation axis 71.

In addition, in the sixth drive device, a fitting 48 having a U-shaped cross section is employed as a member for fixing the wire body to the fixing portion 38a. The fitting 48 is made of metal. The fitting 48 is fixed to the fixing portion 38a by a fastening member such as a bolt 49. It should be noted that a buffer material may be arranged on an inner peripheral surface of the fitting 48 so that the wire body is not damaged.

As such, the member for fixing the wire body is not limited to the binding band, and any member such as a fitting can be employed. A member formed of plastic and having a U-shaped cross section may be employed as the member for binding the plurality of wire bodies. Alternatively, the wire bodies may be fixed to the fixing portion by an adhesive as a member for binding the plurality of wire bodies.

In addition, referring to FIG. 10, in the fifth drive device, a dedicated fitting for arranging the optical cable 51 on the rotation axis 71 or in the vicinity of the rotation axis 71 may be fixed to the fixing portion. Then, another wire body may be arranged around the fitting, and the plurality of wire bodies may be fixed by a binding band or the like.

The drive device according to the present embodiment is arranged in the joint of the robot, but the embodiment is not limited thereto. The drive device according to the present embodiment can be applied to any device that relatively rotates two different members around a rotation axis. For example, the device according to the present embodiment can be applied to a drive device that is arranged on a work tool and drives a constituent member of the work tool, a drive device of an automatic tool changer of a machine tool, or the like.

The above embodiments can be combined as appropriate. In each of the above-described drawings, the same or equivalent parts are denoted by the same sign. The above embodiments are examples and do not limit the invention. In addition, the embodiments include the modifications of the embodiments defined in the claims.

1. A robot comprising:
a drive device configured to rotate a second constituent member of the robot around a rotation axis with respect to a first constituent member of the robot;
a member including a hollow portion extending in a direction along the rotation axis;
an optical cable arranged so as to pass through an inside of the hollow portion;
a first support member arranged on one side in an axial direction of the hollow portion and configured to support the optical cable; and
a second support member arranged on a side opposite to the one side in the axial direction of the hollow portion and configured to support the optical cable, wherein
the first support member is fixed to a member that is stationary when the drive device is driven,
the second support member is fixed to a member that rotates when the drive device is driven,
the first support member and the second support member are configured to support the optical cable substantially on the rotation axis, and
when the drive device is driven, the second support member rotates with respect to the first support member so that the optical cable is twisted between the first support member and the second support member.

2. The robot of claim 1, wherein the member including the hollow portion is arranged in the drive device.

3. The robot of claim 1, comprising an electric wire for supplying electricity, wherein
the electric wire is arranged so as to pass through the inside of the hollow portion, and
the first support member and the second support member are configured to support the electric wire at positions farther away from the rotation axis than the optical cable.

4. The robot of claim 3, comprising an air supply tube for supplying pressurized air, wherein
the air supply tube is formed of a flexible material, and
the first support member and the second support member are configured to support the electric wire at positions farther away from the rotation axis than the optical cable and the air supply tube.

5. The robot of claim 1, wherein
the drive device includes a driver configured to control electricity supplied to the electric motor,
the driver includes a communication device configured to transmit and receive information communicated through the optical cable, and
the communication device is arranged inside a housing of the first constituent member or inside a housing of the second constituent member.

6. The robot of claim 1, comprising a plurality of joints, wherein
the member including the hollow portion is arranged at each of the plurality of joints,
the drive device is arranged at each of the plurality of joints,
a plurality of the drive devices are configured to perform serial communication, and
the optical cable including two optical fibers is inserted into the hollow portion.

7. The robot of claim 6, wherein the optical cable has a structure in which the two optical fibers are fixed to each other and integrated.

8. The robot of claim 1, wherein information communicated through the optical cable includes at least one selected from a group of a position command of the electric motor, a rotational speed command of the electric motor, a current command, a voltage command, information about a position or speed detected by a rotational position detector, information about a current detected by a current detector, information detected by a sensor, and a signal for controlling a work tool.

9. A drive device configured to relatively rotate two members different from each other around a rotation axis, and including a hollow portion extending in a direction along the rotation axis, the drive device comprising:
an electric motor configured to generate a rotational force;
a first support member arranged on one side in an axial direction of the hollow portion and configured to support an optical cable so as to pass through an inside of the hollow portion, and
a second support member arranged on a side opposite to the one side in the axial direction of the hollow portion and configured to support the optical cable, wherein
the first support member is fixed to a constituent member of the drive device that is stationary when the electric motor is driven,
the second support member is fixed to a constituent member of the drive device that rotates when the electric motor is driven,
the first support member and the second support member are configured to support the optical cable substantially on the rotation axis, and
when the electric motor is driven, the second support member rotates with respect to the first support member so that the optical cable is twisted between the first support member and the second support member.
